(19) United States
(12) Patent Application Publication
(10) Pub. No.: US 2009/0157907 A1
(43) Pub. Date: Jun. 18, 2009

(54) Shelf system for rechargeable electronic devices

(75) Inventor: Patricia Ann Chapman, Denver, CO (US)

Correspondence Address: LAW OFFICE OF DALE B. HALLING, 3595 FOUNTAIN BOULEVARD SUITE A2, COLORADO SPRINGS, CO, 80910, US

(73) Assignee: Beagle Design Group LLC

(21) Appl. No.: 12/002,112

(22) Filed: Dec. 14, 2007

(51) Int. Cl. G06F 3/00

(52) U.S. Cl. 710/8

(57) ABSTRACT

The invention is a shelf system for rechargeable electronic devices that has an electrical pole with a number of attachment points. Shelves connect to the attachment points and can pivot between a working position and a stored position. The electrical pole has a number of power ports with different features. For instance, one of the power ports is a 12 volt direct current (DC) port, commonly called a cigarette lighter port. Many travelers will have a 12 VDC plug and cable with them to charge their cell phone, MP3 player or computer. The shelf system also includes a standard electrical outlet in the electrical pole. In addition, the electrical port will have a USB port for those devices that are charged through a USB port. A USB hub is provided in the electrical pole to facilitate this feature.

### RELATED APPLICATIONS

Not Applicable

### STATEMENT REGARDING FEDERALLY SPONSORED RESEARCH

Not Applicable

### THE NAMES OF THE PARTIES TO A JOINT RESEARCH AGREEMENT

Not Applicable

### REFERENCE TO A SEQUENCE LISTING, A TABLE, OR A COMPUTER PROGRAM LISTING

Not Applicable

### BACKGROUND OF THE INVENTION

People carry a number of electronic devices when traveling. When they arrive at their hotel they often place these electronic devices on the floor, desk or dresser in order to access electrical outlets. If they place them on the floor, the electronic devices are in the way and in risk of getting damaged. If they place them on the desk, they are in the way when a person wants to write or read at the desk. If they are placed on the dresser or nightstand they are likely to be accidentally knocked off onto the ground. In addition, there is no way for the traveler to recharge these electronic devices unless they bring along numerous cords and converters.

Thus there exists a need for a shelf system that conveniently stores these electronic devices, provides an easy way to charge these device and does not take up space when not in use.

### BRIEF SUMMARY OF INVENTION

A shelf system for rechargeable electronic devices that overcomes these and other problems has an electrical pole with a number of attachment points. Shelves connect to the attachment points and can pivot between a working position and a stored position. The electrical pole has a number of power ports with different features. For instance, one of the power ports is a 12 volt direct current (DC) port, commonly called a cigarette lighter port. Many travelers will have a 12 VDC plug and cable with them to charge their cell phone, MP3 player or computer. The shelf system also includes a standard electrical outlet in the electrical pole. In addition, the electrical pole will have a USB port for those devices that are charged through a USB port. A USB hub is provided in the electrical pole to facilitate this feature.

### BRIEF DESCRIPTION OF THE SEVERAL VIEWS OF THE DRAWINGS

FIG. 1 is a front view of a shelf system for rechargeable electronic devices in accordance with one embodiment of the invention;

FIG. 2 is a side view of a shelf system for rechargeable electronic devices in accordance with one embodiment of the invention;

FIG. 3 is a block diagram of a shelf system for rechargeable electronic devices in accordance with one embodiment of the invention; and

FIG. 4 is a view of the arm and attachment mechanism for a shelf in accordance with one embodiment of the invention.

### DETAILED DESCRIPTION OF THE INVENTION

The invention is directed to a shelf system for rechargeable electronic devices that has an electrical pole with a number of attachment points. Shelves connect to the attachment points and can pivot between a working position and a stored position. The electrical pole has a number of power ports with different features. For instance, one of the power ports is a 12 volt direct current (DC) port, commonly called a cigarette lighter port. Many travelers will have a 12 VDC plug and cable with them to charge their cell phone, MP3 player or computer. The shelf system also includes a standard electrical outlet in the electrical pole. In addition, the electrical port will have a USB port for those devices that are charged through a USB port. A USB hub is provided in the electrical pole to facilitate this feature.

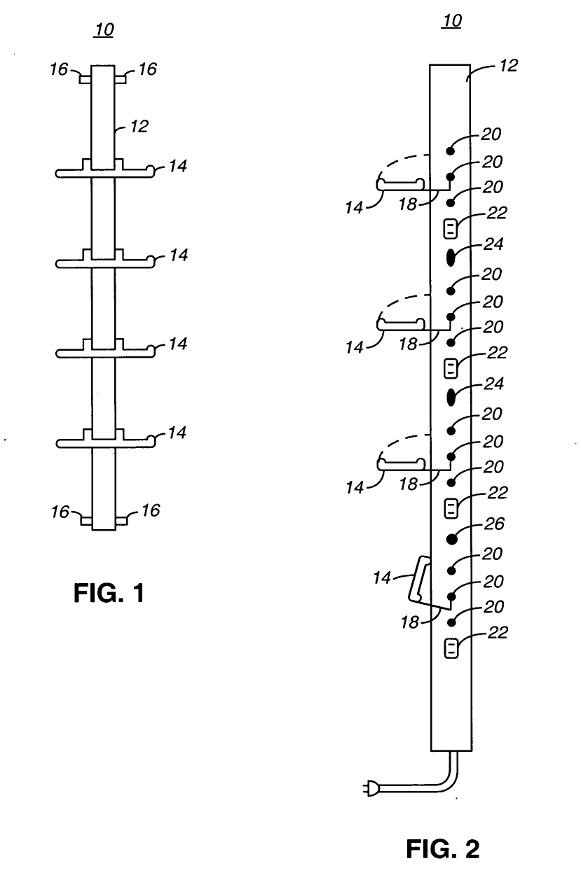

FIG. 1 is a front view of a shelf system 10 for rechargeable electronic devices in accordance with one embodiment of the invention. The system 10 has an electrical pole 12 or post on which a number of shelves 14 are mounted. The electrical pole 12 is mounted to a wall by the mounting brackets 16. In one embodiment, the electrical pole 12 is a metal tube.

FIG. 2 is a side view of a shelf system 10 for rechargeable electronic devices in accordance with one embodiment of the invention. The system 12 shows the shelves 14 in the working position for the top three shelves and in the stored position for the bottom shelf. The shelves 14 have arms 18 that connect to attachment points 20 in the electrical pole 12. The shelves 14 can pivot around the attachment points 20 to move the shelf from a working position to a stored position. The electrical pole 12 has a number of electrical outlets 22, a number of USB (Universal Service Bus) ports 24 and a 12 Volt DC (Direct Current) port 26. This provides the shelf system 10 the ability to charge the user's electronic device using a number of different cables and plugs. Note that in one embodiment the shelves 14 are wire mesh shelves.

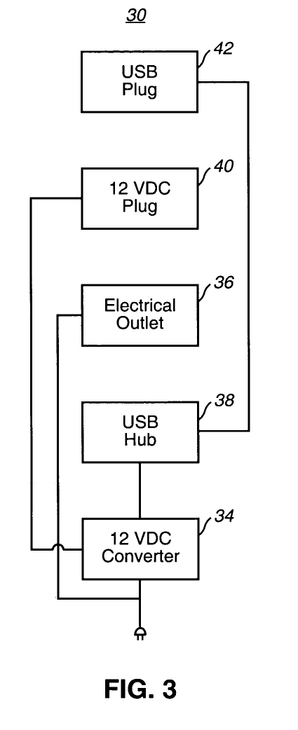

FIG. 3 is a block diagram of a shelf system 30 for rechargeable electronic devices in accordance with one embodiment of the invention. The figure shows a block diagram of the electronics inside the electrical pole 12 or in a base next to the electrical pole 12. An electrical plug 32 is connected to a twelve VDC converter 34 and to an electrical outlet 36. The twelve VDC converter 34 provides power to the USB hub 38 and to a twelve volt plug 40. The USB hub 38 regulates the power to a USB port 42.

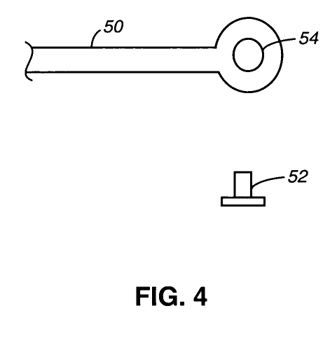

FIG. 4 is a view of the arm 50 and attachment mechanism 52 for a shelf in accordance with one embodiment of the invention. The shelves 14 have arms 50 that connect to attachment points on the electrical pole 12. In one embodiment the arm 50 has a circular opening 54. The circular opening 54 is placed next to a hole in the electrical pole 12 and screw or peg 56 is inserted through the opening 54 into the hole in the electrical pole. In one embodiment the arm 50 is made of a spring steel and the peg 52 has a friction fit into the hole of the electrical pole. As will be apparent to those skilled in the art a number of other attachment systems may be used and these attachment mechanisms are within the scope of the invention.

Thus there has been described a shelf system that conveniently stores these electronic devices, provides an easy way to charge these devices and does not take up horizontal space when not in use.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A shelf system for rechargeable electronic devices, comprising:
an electrical pole having a plurality of attachment points;
a plurality of shelves that connect to the attachment points and can pivot between a working position and a stored position; and
power port in the electrical pole.

2. The shelf system of claim 1, wherein the power port is a USB port.

3. The shelf system of claim 2, further including a USB hub attached to the USB port.

4. The shelf system of claim 1, wherein the power port is an electrical outlet.

5. The shelf system of claim 1, wherein the power port is a 12 volt port.

6. The shelf system of claim 5, further including a 12 volt converter in the electrical pole.

7. The shelf system of claim 1, wherein the plurality of shelves have arms that connect to the attachment points.

8. A shelf system for rechargeable electronic devices, comprising:
a post;
a shelf attached to the post having a working position and a stored position; and
a power port in the post.

9. The system of claim 8, wherein the post is a hollow metal tube.

10. The system of claim 8, wherein the shelf pivots between the working position and the stored position.

11. The system of claim 10, wherein the power port is a USB port.

12. The system of claim 11, further including a USB hub attached to the USB port.

13. The system of claim 9, wherein the power port is an electrical outlet.

14. The system of claim 9, wherein the power port is a 12 volt outlet.

15. The system of claim 14, further including a 12 volt converter in the post.

16. The system of claim 8, wherein the shelf is a metal mesh shelf.

17. A shelf system for rechargeable electronic devices, comprising:
a single electrical pole having a plurality of attachment points;
a plurality of shelves having arms that connect to the attachment points and can pivot between a working position and a stored position;
a USB port in the single electrical pole;
an electrical outlet in the single electrical pole; and
a 12 volt outlet in the single electrical pole.

18. The system of claim 17, further including a USB hub in the single electrical pole.

19. The system of claim 18, further including a 12 volt converter in the single electrical pole.
